(19) United States
(12) Patent Application Publication
(10) Pub. No.: US 2011/0082923 A1
(43) Pub. Date: Apr. 7, 2011

(54) COMMUNICATION APPARATUS HAVING A PLURALITY OF NETWORK INTERFACES, METHOD FOR CONTROLLING THE COMMUNICATION APPARATUS, AND STORAGE MEDIUM

(75) Inventor: Hiroki SHOUNO, Kawasaki-shi (JP)

(73) Assignee: CANON KABUSHIKI KAISHA, Tokyo (JP)

(21) Appl. No.: 12/896,258

(22) Filed: Oct. 1, 2010

(30) Foreign Application Priority Data
Oct. 2, 2009 (JP) 2009-230596

(51) Int. Cl. G06F 15/173

(52) U.S. Cl. 709/223

(57) ABSTRACT

A communication apparatus having a plurality of network interfaces and capable of properly returning MIB information requested by an external apparatus, even when a network interface actually in communication with the external apparatus and a network interface designated by the external apparatus are different. If it is determined that a value of interface information contained in a MIB information retrieval request received by a communication unit from an external apparatus is a predetermined value and a first network interface has received the request, information corresponding to the first network interface is created from the MIB information and returned to the external apparatus. If it is determined that the value is the predetermined value and that a second network interface has received the request, information corresponding to the second network interface is created from the MIB information and returned to the external apparatus.

### BACKGROUND OF THE INVENTION

1. Field of the Invention

The present invention relates to a communication apparatus having a plurality of network interfaces, a method for controlling the communication apparatus, and a non-transitory computer-readable storage medium, and more particularly to a method of responding to a request for MIB (Management Information Base) information retrieval from an external apparatus.

2. Description of the Related Art

Conventionally, to perform management of communication devices on a network, SNMP (Simple Network Management Protocol) is often used. The SNMP is a protocol which operates on UDP/IP (User Datagram Protocol/Internet Protocol), for monitoring and controlling a communication device by retrieving information on the communication device or configuring the communication device.

In communication device control using SNMP, a communication device to be controlled (SNMP agent) has a database called MIB (Management Information Base). On the other hand, an external apparatus as a controller (SNMP manager) retrieves MIB information from the communication device using SNMP, and performs configuration of the communication device. The MIB defines various kinds of state information on the communication device, which are classified into a standard MIB defined by RFC (Request For Comments) as general information and a private MIB defined by each vendor.

When the SNMP manager retrieves MIB information from an SNMP agent or performs configuration of the SNMP agent using SNMP, an object

ID is used to uniquely identify a managed object (hereinafter referred to as “a MIB object”). A unique object ID is assigned to each of all MIB objects of standard MIBs and private MIBs. For example, a MIB object sysDescr, which represents description of a device, has an object ID of 1.3.6.1.2.1.1.1.

Some MIB objects each have only one item of information, and other MIB objects each have a plurality of items of information. For example, for a MIB object ifPhysAddress which is indicative of a physical address of a network interface, if a communication device has a plurality of network interfaces, there are a corresponding number of MAC addresses of the network interfaces. As a consequence, ifPhysAddress has a plurality of items of information. Therefore, even though a MIB object is uniquely identified by an object ID, if the MIB object has a plurality of items of information, it is not possible to identify each item of information by the object ID.

To eliminate this inconvenience, there has been conventionally employed a method of using an index for identifying each of plurality of items of information on each MIB object. The index is used for identifying what number an item of information is in the plurality of items of information on a MIB object. If a desired MIB object has only one item of information, the MIB object is indicated by adding “.0” after the object ID thereof. For example, in the case of the MIB object sysDescr, it is indicated by 1.3.6.1.2.1.1.1.0.

If a desired MIB has a plurality of items of information, each of them is indicated by adding an index indicative of what number it is in the plurality of items, after the object ID of the MIB object. For example, there is a MIB object ifType which is indicative of a type of a network interface. The MIB object ifType has an object ID of is 1.3.6.1.2.1.2.2.1.3. In this case, when a communication device has a plurality of network interfaces, to indicate what number a network interface is, an item of information is uniquely identified by adding an index after the object ID. For example, to designate a third network interface, the MIB object ifType is defined as 1.3.6.1.2.1.2.2.1.3.3.

When performing retrieval of information from the SNMP agent and configuring the SNMP agent, a combination of an object ID and an index, which is designated as described above, enables the SNMP manager to handle information on a predetermined object.

Further, also in a case of constructing a MIB by collecting information on a plurality of communication devices, the index is used for identifying each of a plurality of items of information on each MIB object. For example, when a gateway device provided between an SNMP manager and SNMP agents transfers an SNMP request for MIB information retrieval to the SNMP agents, an index added to an object ID contained in the SNMP request is deleted, and then the SNMP request is transferred to each of the SNMP agents.

Then, when transferring respective SNMP responses from the SNMP agents, each SNMP response is transferred to the SNMP manager by attaching an index value to thereby make the index values free from inconsistency even in such an environment where a plurality of SNMP agents are installed. This mechanism has been proposed e.g. in Japanese Patent Laid-Open Publication No. 2005-130210.

Further, in general, an index is configured such that the index itself is a MIB object, and, as described above, a value thereof is used as an index of another MIB object. For example, in the case of the above-mentioned index of the MIB object ifType, a value of a MIB object ifIndex which has a meaning of a value for uniquely identifying a network interface, as is, forms the index of the MIB object ifType. As mentioned above, the index provides a mechanism for identifying, when a MIB object has a plurality of items of information, what number each item of information is.

Some SNMP managers request MIB information retrieval by designating a fixed value of 1 for the MIB object ifIndex for identifying a network interface. Presumably, this is because there have conventionally been a very small number of communication devices having a plurality of network interfaces, and therefore even by designating a fixed value of 1 for the MIB object ifIndex, it has been possible to designate the first (single) network interface. When such an SNMP manager attempts to acquire MIB information from an SNMP agent having a plurality of network interfaces, there occur the following problems.

For example, there is a case where an external apparatus (SNMP manager) that designates a fixed value of 1 for ifIndex attempts to acquire MIB information on a network interface from a communication device (SNMP agent) equipped with a first network interface having an ifIndex of 1 and a second network interface having an ifIndex of 2. In this case, there is a fear that the MIB information which is not desired by the external apparatus is retrieved. This is because even when the second one is a network interface via which the communication device is in communication with the external apparatus, since the external apparatus fixedly designates the MIB object ifIndex by 1, the communication device returns the MIB information on the first network interface.

Normally, if the network interface of the communication device in communication with the external apparatus is the second one, it is considered that MIB information desired by the external apparatus is information on the second network interface. Therefore, if the communication device returns the information on a network interface which is different from the network interface in actual communication, this causes the external apparatus as the SNMP manager to acquire unintended information.

### SUMMARY OF THE INVENTION

The present invention provides a communication apparatus having a plurality of network interfaces and a method of communication by the communication apparatus which are capable of properly returning MIB information requested by an external apparatus, even when a network interface which is actually in communication with the external apparatus and a network interface which is designated by the external apparatus are different, and a non-transitory computer-readable storage medium storing a computer-executable program for executing the method.

In a first aspect of the present invention, there is provided a communication apparatus including a first network interface, a second network interface, a communication unit for performing communication using SNMP via at least one of the network interfaces, and a storage unit for storing state information on the communication apparatus as MIB information, comprising a first determination unit configured to determine whether or not a value of interface information, which is contained in a MIB information retrieval request received by the communication unit from an external apparatus, is a predetermined value, a second determination unit configured to determine which one of the network interface has received the MIB information retrieval request, and a returning unit configured to create information corresponding to the first network interface from the MIB information and to return the created information to the external apparatus, if it is determined by the first determination unit that the value of the interface information is the predetermined value and if it is determined by the second determination unit that the first network interface has received the MIB information retrieval request, and to create information corresponding to the second network interface from the MIB information and to return the created information to the external apparatus, if it is determined by the first determination unit that the value of the interface information is the predetermined value and if it is determined by the second determination unit that the second network interface has received the MIB information retrieval request.

In a second aspect of the present invention, there is provided a method for controlling a communication apparatus including a first network interface, a second network interface, a communication unit for performing communication using SNMP via at least one of the network interfaces, and a storage unit for storing state information on the communication apparatus as MIB information, comprising determining whether or not a value of interface information, which is contained in a MIB information retrieval request received by the communication unit from an external apparatus, is a predetermined value, determining which one of the network interfaces has received the MIB information retrieval request, creating information corresponding to the first network interface from the MIB information and returning the created information to the external apparatus, if it is determined that the value of the interface information is the predetermined value and if it is determined that the first network interface has received the MIB information retrieval request, and creating information corresponding to the second network interface from the MIB information and returning the created information to the external apparatus, if it is determined that the value of the interface information is the predetermined value and if it is determined that the second network interface has received the MIB information retrieval request.

In a third aspect of the present invention, there is provided a non-transitory computer-readable storage medium storing a computer-readable program for causing a computer to execute a method for controlling a communication apparatus including a first network interface, a second network interface, a communication unit for performing communication using SNMP via at least one of the network interfaces, and a storage unit for storing state information on the communication apparatus as MIB information, wherein the method comprises determining whether or not a value of interface information, which is contained in a MIB information retrieval request received by the communication unit from an external apparatus, is a predetermined value, determining which one of the network interfaces has received the MIB information retrieval request, creating information corresponding to the first network interface from the MIB information, and returning the created information to the external apparatus, if it is determined that the value of the interface information is the predetermined value and if it is determined that the first network interface has received the MIB information retrieval request, and creating information corresponding to the second network interface from the MIB information and returning the created information to the external apparatus, if it is determined that the value of the interface information is the predetermined value and if it is determined that the second network interface has received the MIB information retrieval request.

According to the present invention, even when the network interface which is actually in communication with the external apparatus and the network interface which is designated by the external apparatus are different, it is possible to properly return the MIB information requested by the external apparatus.

Further features of the present invention will become apparent from the following description of exemplary embodiments with reference to the attached drawings.

### BRIEF DESCRIPTION OF THE DRAWINGS

FIG. 1 is a diagram showing an example of a network environment to which is connected an MFP which is an image forming apparatus as a communication apparatus according to a first embodiment of the present invention.

FIG. 2 is a schematic block diagram of essential parts of the MFP appearing in FIG. 1.

FIG. 3 is a block diagram showing software configuration of a communication function of the MFP.

FIG. 4 is a flowchart of an operation process executed by the MFP upon receipt of an SNMP request.

FIGS. 5A and 5B show an example of a network packet of an SNMP request for information retrieval, which is received by the MFP via a network interface-A.

FIGS. 6A and 6B show an example of a network packet of an SNMP response returned by the MFP to a requesting source.

FIGS. 7A and 7B show an example of a network packet of an SNMP request for information retrieval, which is received by the MFP via a network interface-B.

FIGS. 8A and 8B show an example of a network packet of an SNMP response returned by the MFP to the requesting source.

FIG. 9 is a block diagram showing software configuration of a communication function of an MFP which is an image forming apparatus as a communication apparatus according to a second embodiment of the present invention.

FIG. 10 shows a format of MIB information of a first MIB and a second MIB in a visualized form.

FIG. 11 is a flowchart of an operation process executed by the MFP upon receipt of an SNMP request.

FIGS. 12A and 12B show an example of a network packet of an SNMP request for information retrieval, which is received by the MFP via a network interface-A.

FIGS. 13A and 13B show an example of a network packet of an SNMP response returned by the MFP to a requesting source.

FIGS. 14A and 14B show an example of a network packet of an SNMP request for information retrieval, which is received by the MFP via a network interface-B.

FIGS. 15A and 15B show an example of a network packet of an SNMP response returned by the MFP to the requesting source.

### DETAILED DESCRIPTION OF THE EMBODIMENTS

The present invention will now be described in detail below with reference to the accompanying drawings showing embodiments thereof.

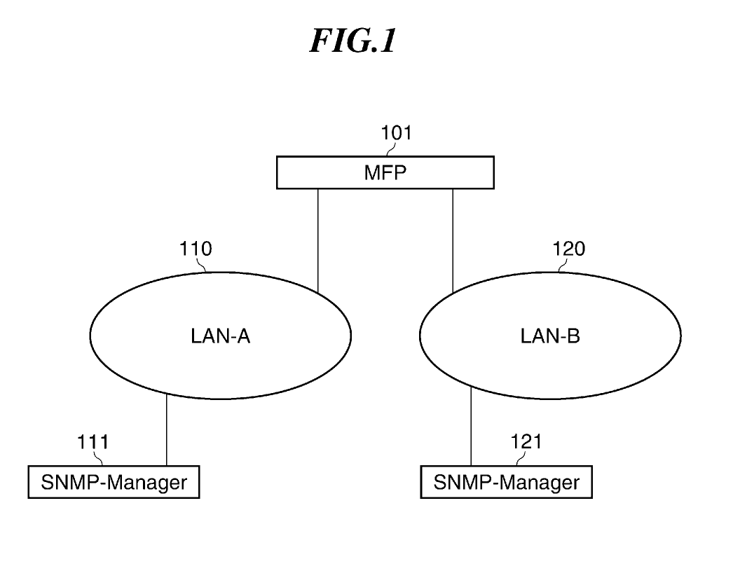

FIG. 1 is a diagram showing an example of a network environment to which is connected an MFP (multifunction peripheral) which is an image forming apparatus as a communication apparatus according to a first embodiment of the present invention.

Referring to FIG. 1, the above-mentioned MFP, denoted by reference numeral 101, is provided with two network interfaces. One of the two network interfaces is connected to a LAN (Local Area Network)-A 110, and the other is connected to a LAN-B 120. It is assumed that each of the LAN-A 110 and the LAN-B 120 is implemented by an Ethernet (registered trademark).

An SNMP manager 111 is connected to the LAN-A 110 such that the SNMP manager 111 can communicate with the MFP 101 using the SNMP protocol. An SNMP manager 121 is connected to the LAN-B 120 such that the SNMP manager 121 can communicate with the MFP 101 using the SNMP protocol. The SNMP managers 111 and 121 are each implemented by an information processing apparatus, such as a server.

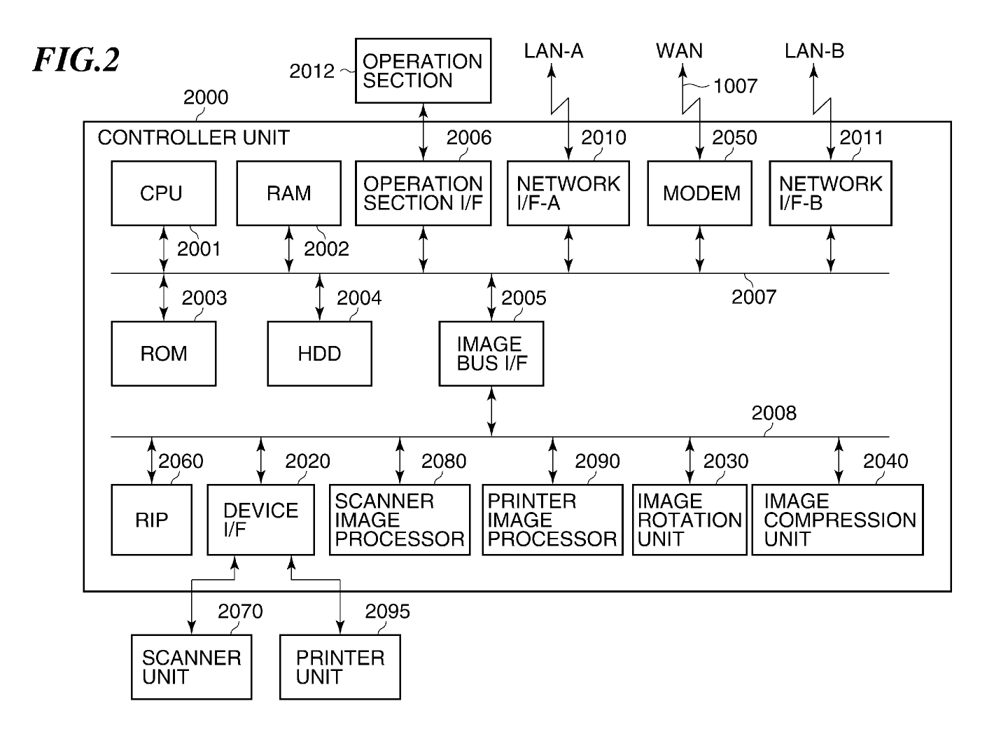

FIG. 2 is a schematic block diagram of essential parts of the MFP 101 appearing in FIG. 1.

A controller unit 2000 is a controller that controls the overall operation of the MFP 101. The controller unit 2000 is connected to a scanner unit 2070 as an image input device and a printer unit 2095 as an image output device, and performs control for realizing a copy function of causing the printer unit 2095 to print out image data read by the scanner unit 2070.

The controller unit 2000 is provided with component elements described below. A CPU (Central Processing Unit) 2001 starts up an operation system (OS) by a boot program stored in a ROM (Read Only Memory) 2003, and executes application programs stored in a HDD (Hard Disk Drive) 2004 on the OS to thereby carry out various operations. A RAM (Random Access Memory) 2002 is used as a work area for the CPU 2001. The RAM 2002 is also used as an image memory for temporarily storing image data.

The HDD 2004 stores not only the above-mentioned application programs, but also image data. Connected to the CPU 2001 via a system bus 2007 are an operation section interface 2006, a network interface-A 2010, a network interface-B 2011, a modem 2050, and an image bus interface 2005.

The operation section interface 2006 provides interface for communication with an operation section 2012 having a touch panel, and image data to be displayed on the operation section 2012 is output to the operation section 2012 via the operation section interface 2006. Further, the operation section interface 2006 transfers information input by a user via the operation section 2012 to the CPU 2001.

The network interface-A 2010 (first network interface), which is formed by integrating a network interface card (NIC) into an ASIC (Application Specific Integrated Circuit), is connected to the LAN-A 110. Similarly, the network interface-B 2011 (second network interface) is formed by integrating a NIC into an ASIC, and is connected to the LAN-B 120. The modem 2050 is connected to a public communication line (WAN) 1007 to transmit and receive information via the WAN 1007.

The image bus interface 2005 is a bus bridge that connects between the system bus 2007 and an image bus 2008 that transfers image data at high speed, and performs conversion of data format. The image bus 2008 is implemented by a PCI bus or an IEEE 1394. On the image bus 2008, there are provided a raster image processor (RIP) 2060, a device interface 2020, a scanner image processor 2080, a printer image processor 2090, an image rotation unit 2030, and an image compression unit 2040.

The RIP 2060 is a processor that rasterizes PDL code into a bitmap image. The device interface 2020 is connected to the scanner unit 2070 and the printer unit 2095, and performs synchronous-to-asynchronous or asynchronous-to-synchronous conversion of image data. The scanner image processor 2080 corrects, manipulates, and edits input image data. The printer image processor 2090 performs correction, resolution conversion, etc. of image data to be printed out. The image rotation unit 2030 rotates image data. The image compression unit 2040 compresses multi-valued image data into e.g. JPEG data, and binary image data into JBIG, MMR, or MH-formatted data, as well as performs expansion of the compressed data.

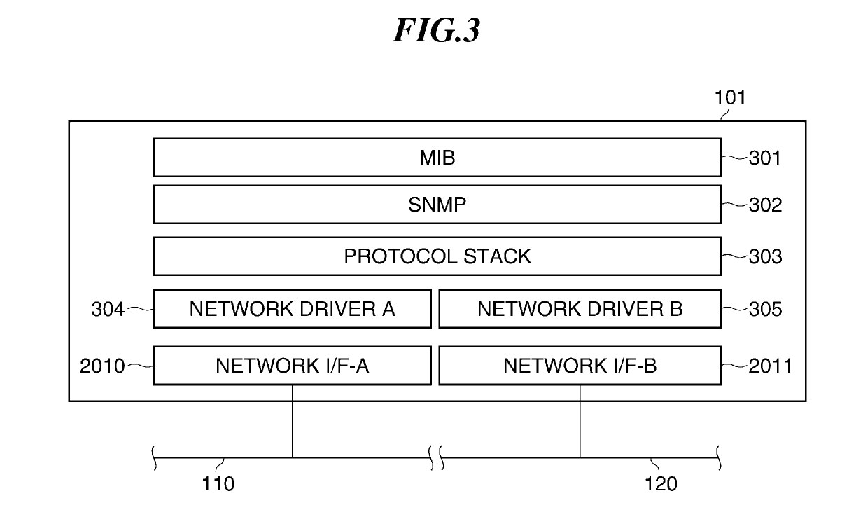

FIG. 3 is a block diagram showing software configuration of a communication function of the MFP 101. It should be noted that FIG. 3 shows only essential parts related to the present invention, and the essential parts partially include hardware.

A MIB 301 is a MIB (Management Information Base) that stores state information on the MFP 101 in a manner identifiable according to identification information, and comprises a database body and software for constructing the database body. The MIB 301 internally constructs a database by collecting various kinds of information on the MFP 101, and returns a MIB value corresponding to an object ID and an index value designated by an SNMP 302, referred to hereinafter. The object ID is identification information for uniquely identifying a MIB object. The index is identification information for identifying what number an item of information is in items of information on the MIB object.

Further, it is assumed that the MIB 301 has a standard MIB (MIB 2). It is also assumed that the network interface-A 2010 has an ifIndex of 1 assigned thereto and the network interface-B 2011 has an ifIndex of 2 assigned thereto.

The SNMP 302 is an agent of the SNMP protocol. The SNMP 302 queries the MIB 301 about a MIB value corresponding to the designated object ID and index value based on a packet of an SNMP request received via the network interface-A 2010 or the network interface-B 2011. Then, the SNMP 302 receives the MIB value returned from the MIB 301, and creates a packet of an SNMP response to transmit the same to the external apparatus on the network. The external apparatus is the apparatus having requested retrieval of the MIB information, and is the SNMP manager 111 or 121, for example.

A protocol stack 303 is responsible for a communication function of IP protocols, and is incorporated in the OS as standard equipment. A network driver A 304 is a device driver for controlling the network interface-A 2010. A network driver B 305 is a device driver for controlling the network interface-B 2011.

The above-mentioned software group of the application programs ranging from the MIB 301 to the network driver B 305, the network interface-A 2010, and the network interface-B 2011 is stored in the HDD 2004 when not in use, and each software program is loaded into the RAM 2002 as required, for execution by the CPU 2001. Further, the MIB 301 and the SNMP 302 operate in an application space of the OS. The protocol stack 303 to the network driver B 305, the network interface-A 2010 and the I/F-B 2011 operate in a kernel space of the OS.

It should be noted that the OS on which the software programs operate and software groups for realizing other functions of the MFP are also stored in the HDD 2004, and are each loaded into the RAM 2002 as required, for execution by the CPU 2001.

Further, in the present embodiment, it is assumed that an IP address associated with the network interface-A 2010 is 172.24.176.168, a hardware address associated with the network interface-A 2010 is 000085D6E21. Further, it is assumed that an IP address associated with the network interface-B 2011 is 192.168.1.100, and a hardware address associated with the network interface-B 2011 is 000085112233.

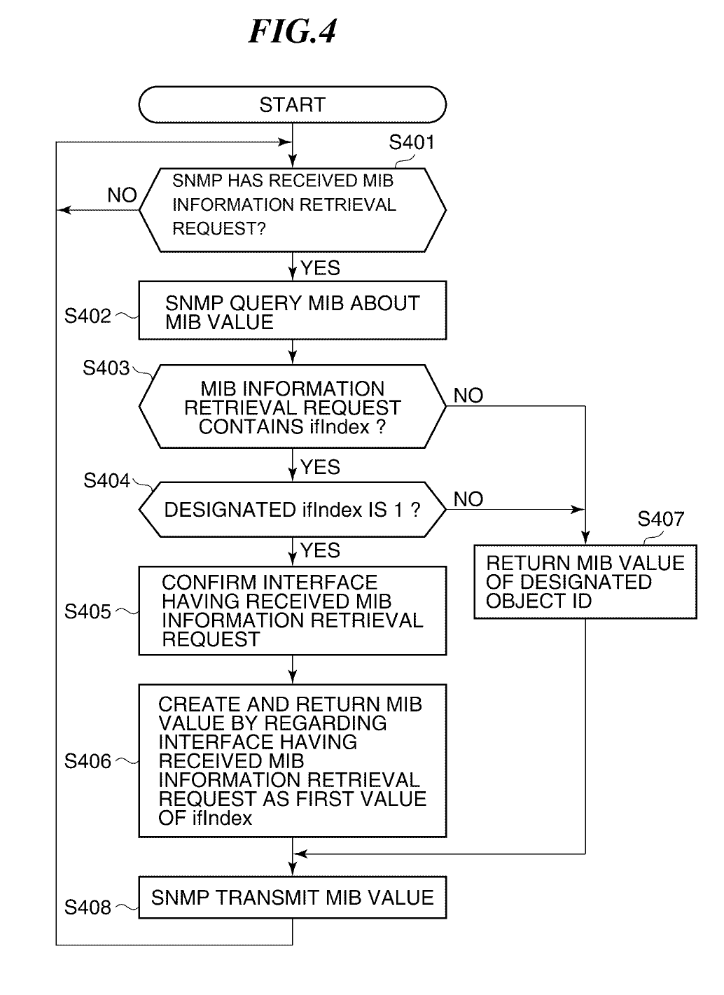

Next, a description will be given of an operation of the MFP 101 performed when an SNMP request is received, with reference to FIG. 4.

FIG. 4 is a flowchart of an operation process executed by the MFP 101 upon receipt of the SNMP request.

First, a description will be given of a case where an SNMP request for MIB information retrieval is received via the network interface-A 2010.

In a step S401, the SNMP 302 awaits an SNMP request for information retrieval from an external apparatus. The SNMP request for information retrieval is an SNMP message sent by the SNMP manager for requesting a SNMP agent to return a MIB value, such as a Get-Request message and a GetNext message.

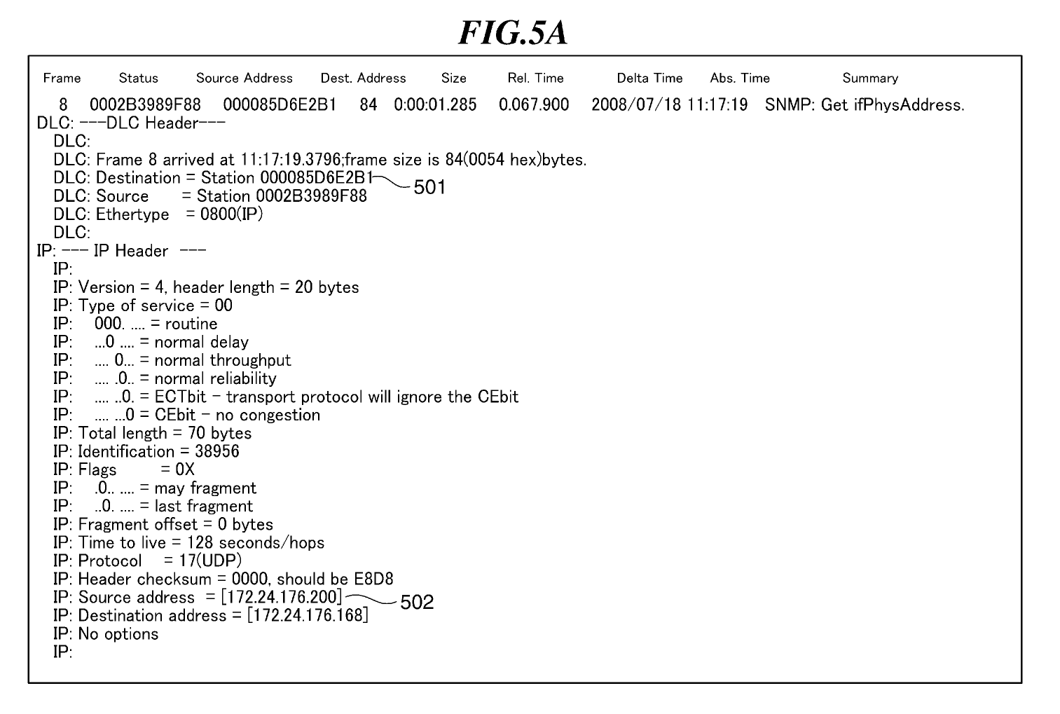

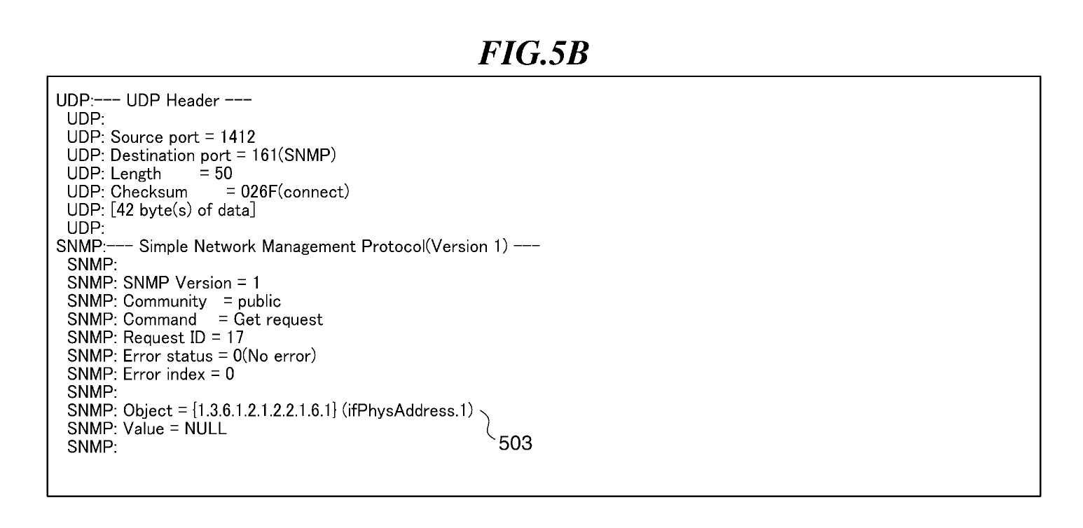

In the step S401, when the SNMP 302 receives an SNMP request for MIB information retrieval, the process proceeds to a step S402. FIGS. 5A and 5B show the contents of a network packet of the SNMP request for information retrieval, which is received by the MFP 101 via the network interface-A 2010, in a form visualized from the viewpoint of the protocol layer.

Referring to FIGS. 5A and 5B, a value 501 indicates a destination hardware address in a data link layer. This value is the hardware address of the network interface-A 2010. A value 502 indicates a destination IP address contained in an Internet layer. This value is the IP address associated with the network interface-A 2010. A value 503 indicates an object ID and index of a MIB object, contained in the

SNMP message, information on which is requested for retrieval. In this network packet, the object ID is 1.3.6.1.2.1.2.2.1.6, and the index is 1. The meaning of this object ID will be described hereinafter when a step S403 is described. In the present example, it is assumed that such a packet has been received.

Referring again to FIG. 4, in the step S402, the SNMP 302 performs processing of requesting the MIB 301 to return a MIB value designated by the SNMP request for information retrieval. More specifically, the SNMP 302 passes the object ID and index value designated by the SNMP request for information retrieval, which is received in the step S401, to the MIB 301 to request the corresponding MIB value. At this time, the SNMP 302 also passes interface information on the SNMP request received in the step S401 to the MIB 301. The term “interface information” here is intended to mean information for discriminating between the network interface-A 2010 and the network interface-B 2011 from each other.

Next, in the step S403, the MIB 301 determines whether or not the request for MIB value retrieval received from the SNMP 302 in the step S402 contains ifIndex as an index. More specifically, the MIB 301 refers to the object ID and the index value at the trailing end of a MIB object requested by the SNMP 302, and checks whether or not iflndex is contained in the designated MIB value by comparing against the database thereof. For example, let it be assumed that a combination of the object ID and index value at the trailing end of the designated MIB value is 1.3.6.1.2.1.2.2.1.6.1. Here, 1.3.6.1.2.1.2.2.1.6 is the object ID indicative of ifPhysAddress. Since the index of ifPhysAddress is iflndex, so that the answer to the question of the step S403 is affirmative (YES), so that the process proceeds to a step S404. If the requesting designating the MIB object does not contain iflndex in the step S403, the process proceeds to a step S407.

In the step S404, the MIB 301 determines whether or not the value of iflndex contained in the MIB value retrieval request received from the SNMP 302 in the step S402 is 1. The step S404 is an example of an operation of an iflndex-determining unit. Let it be assumed, for example, as mentioned above, that the combination of the designated object ID and index at the trailing end is 1.3.6.1.2.1.2.2.1.2.1. Here, since the index value is a rightmost value, the value of iflndex is 1, so that the answer to the question of the step S404 is affirmative (YES), and then the process proceeds to a step S405. On the other hand, if the value of ifIndex is not 1, the process proceeds to the step S407.

In the step S405, the MIB 301 confirms the network interface which has received the SNMP request for MIB information retrieval from the external apparatus in the step S401. More specifically, based on the interface information received from the SNMP 302, the MIB 301 determines which of the network interface-A 2010 and the network-I/F B 2011 has received the SNMP request for MIB information retrieval. Here, it is determined that the network-I/F which has received the request is the network interface-A 2010.

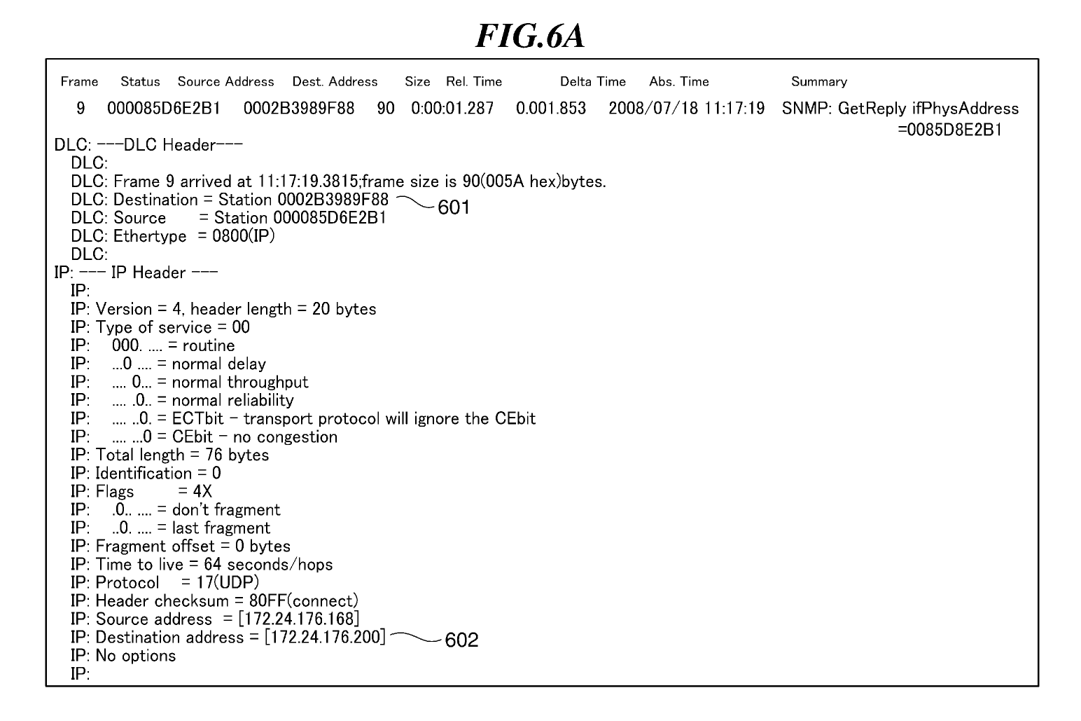

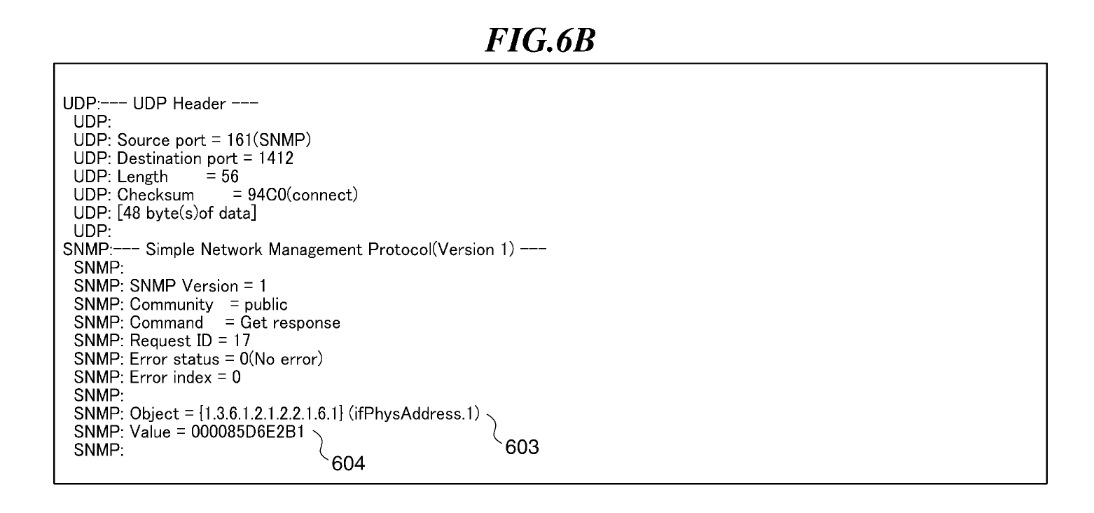

Next, in a step S406, the MIB 301 creates a MIB value by regarding the value of ifIndex associated with the network I/F determined in the step S405 as 1. It is determined in the step S405 that the network I/F which has received the SNMP request for MIB information retrieval is the network interface-A 2010, and hence the MIB object on which information is to be retrieved is ifPhysAddress. Therefore, the MIB 301 acquires a value of ifPhysAddress associated with the network interface-A2010, i.e. the value of the hardware address of the network interface-A 2010 from the network driver A 304. Then, the MIB 301 returns the value of the hardware address of the network interface-A 2010 to the SNMP 302 as the value of the MIB object+index (1.3.6.1.2.1.2.2.1.6.1) queried by the SNMP 302. FIGS. 6A and 6B show the contents of a network packet of an SNMP response returned in this step, in a form visualized from the viewpoint of the protocol layer.

Referring to FIGS. 6A and 6B, a value 601 indicates a hardware address of a packet transmission source. In the present example, since the packet is transmitted from the network interface-A 2010, the value 601 is the hardware address of the network interface-A 2010. A value 602 indicates an IP address of the packet transmission source, i.e. the IP address associated with the network interface-A 2010. A value 603 indicates the object ID and index of the MIB object on which information is to be returned, contained in the present responding SNMP message. Here, the object ID is 1.3.6.1.2.1.2.2.1.6, and the index is 1. These values are identical to those of the MIB object on which information has been requested, and are identical to the value 503 shown in FIG. 5B.

A value 604 is the MIB value of the value 603. This MIB object is ifPhysAddress. In the present example, since iflndex is designated by 1 in the step S401, the value of the hardware address is the value of the network interface-A 2010 which is the network I/F having received the SNMP request for MIB information retrieval in the step S401. Therefore, in cases where the MIB object in the MIB information retrieval request received by the MFP 101 contains 1 as the value of ifIndex, it is possible to return the information on the network I/F which has received the request, by regarding the value of ifIndex as 1.

In the step S407, the MIB 301 performs creation of a MIB value without considering processing of ifIndex. The step S407 is executed only if either of the following conditions is satisfied: (1) A combination of the designated object ID and index does not contain ifIndex, i.e. the answer to the question of the step S403 is negative (NO). (2) Although a combination of the designated object ID and index contains ifIndex, the value of ifIndex is other than 1, i.e. the answer to the question of the step S404 is negative (NO). In these two cases, the designated original MIB value is returned. The MIB 301 returns the MIB value associated with the object ID and index received from the SNMP 302 in the step S402 to the SNMP 302.

In a step S408, the SNMP 302 transmits the MIB value returned from the MIB 301 to the external apparatus which is the requesting source, by using the SNMP message, and then the process returns to the step S401.

Next, a description will be given of an operation when the SNMP request for MIB information retrieval is received via the network interface-B 2011. It should be noted that in the case where same processing is executed as described hereinabove with reference to the steps S401 to S408, part of the description is omitted.

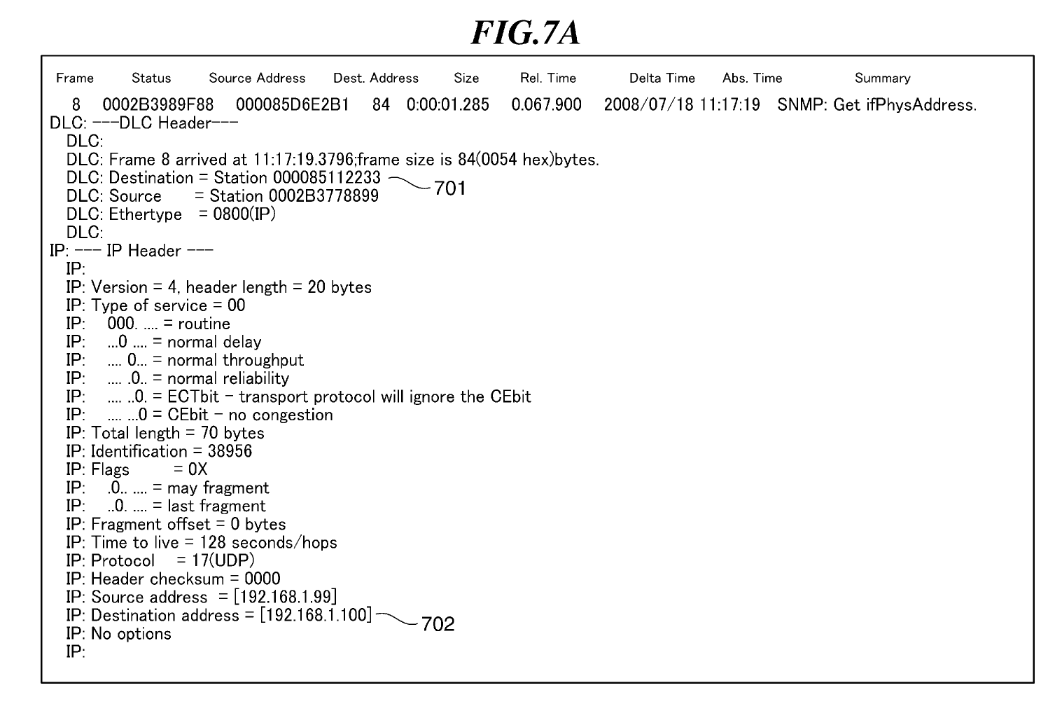

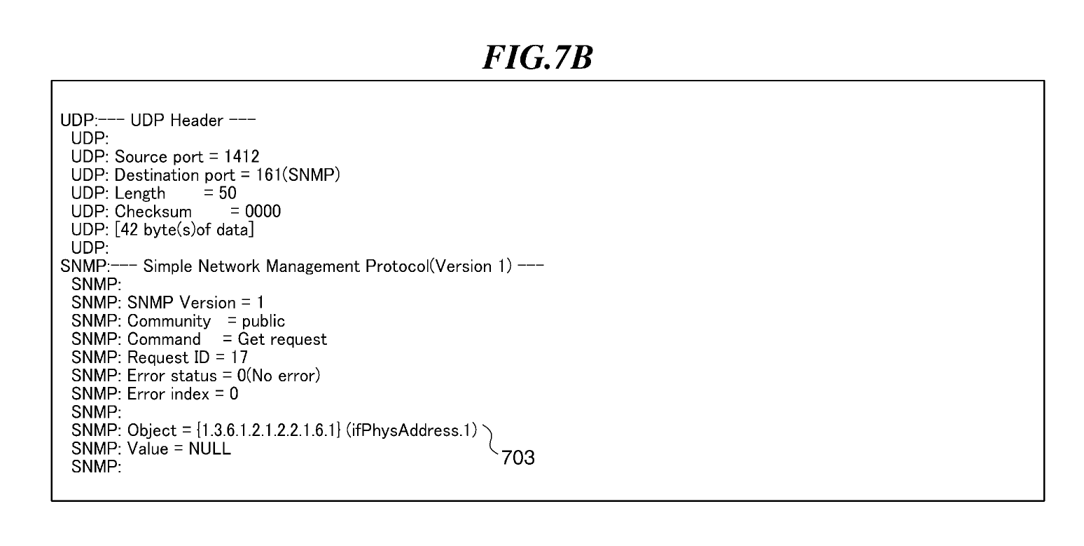

In the step S401, similarly to the above description, the SNMP 302 awaits an SNMP request for information retrieval from the external apparatus. If the SNMP 302 receives the SNMP request for MIB information retrieval, the process proceeds to the step S402. FIGS. 7A and 7B show the contents of a network packet of the SNMP request for information retrieval, which is received by the MFP 101 via the network interface-B 2011, in a form visualized from the viewpoint of the protocol layer.

Referring to FIGS. 7A and 7B, a value 701 indicates a destination hardware address in the data link layer. This value is the hardware address of the network interface-B 2011. A value 702 indicates a destination IP address contained in the Internet layer. This value is the IP address associated with the network interface-B 2011. A value 703 indicates the object ID and index of the MIB object information on which is to be retrieved, contained in the SNMP message. Here, the object ID is 1.3.6.1.2.1.2.2.1.6, and the index is 1. The meaning of this object ID will be described hereinafter with reference to the step S403. It is assumed here that such a packet has been received.

Referring again to FIG. 4, in the step S402, similarly to the above description, the SNMP 302 performs processing of requesting the MIB 301 to return the MIB value designated by the SNMP request for information retrieval.

Next, in the step S403, similarly to the above description, the MIB 301 determines whether or not the request for MIB value retrieval received from the SNMP 302 in the step S402 contains ifIndex as an index. If the request designating the MIB object does not contain ifIndex, the process proceeds to the step S407. On the other hand, if the request designating the MIB object contains ifIndex, the process proceeds to the step S404.

In the step S404, similarly to the above description, the MIB 301 determines whether or not the value of ifIndex contained in the MIB value retrieval request received from the SNMP 302 in the step S402 is 1. If the value of ifIndex is not 1, the process proceeds to the step S407, whereas if the value of ifIndex is 1, the process proceeds to the step S405.

In the step S405, the MIB 301 confirms the network interface which has received the SNMP request for MIB information retrieval from the external apparatus in the step S401. In this step, similarly to the above, based on the interface information received from the SNMP 302 in the step S402, the MIB 301 determines which of the network interface-A 2010 and the network interface-B 2011 is the network I/F which has received the request. Here, it is determined that the network interface which has received the request is the network interface-B 2011.

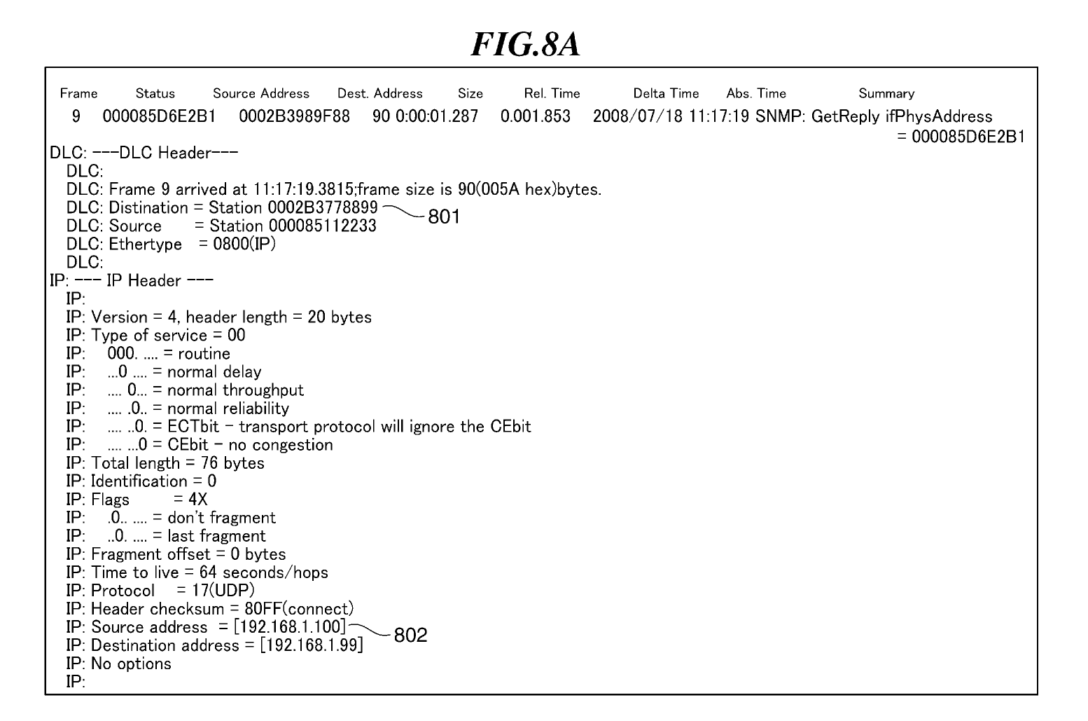

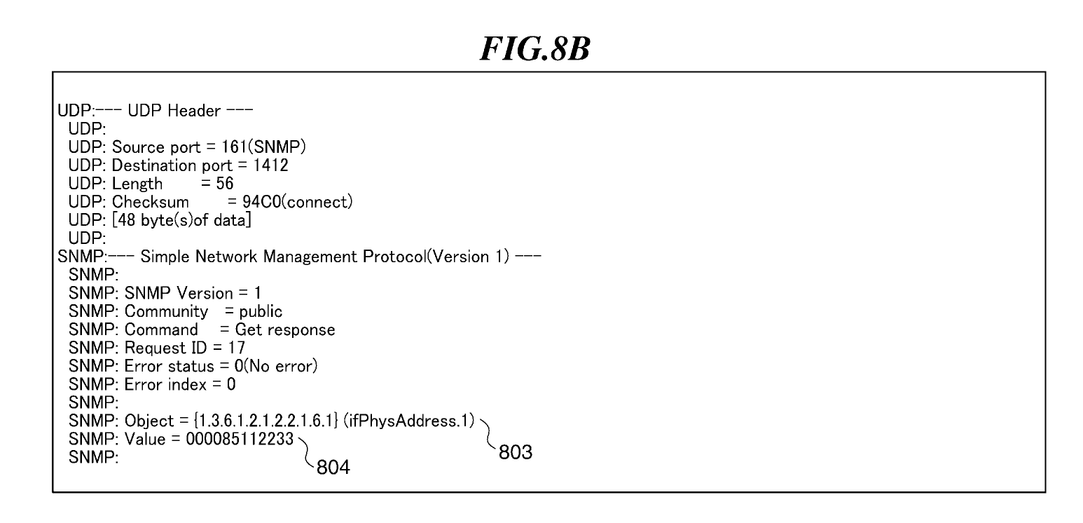

Next, in the step S406, similarly to the above description, the MIB 301 creates a MIB value by regarding the value of ifIndex associated with the network interface determined in the step S405 as 1. It is determined in the step S405 that the network interface which has received the SNMP request for MIB information retrieval is the network interface-A I/F-B 2011, and hence the MIB object on which information is to be retrieved is ifPhysAddress. Therefore, the MIB 301 acquires a value of ifPhysAddress associated with the network interface-B 2011, i.e. the value of the hardware address of the network interface-B 2011 from the network driver B 305. Then, the MIB 301 returns the value of the hardware address of the network interface-B 2011 to the SNMP 302 as the value of the MIB object+index (1.3.6.1.2.1.2.2.1.6.1) queried by the SNMP 302. FIGS. 8A and 8B show the contents of a network packet of an SNMP response returned in this step, in a form visualized from the viewpoint of the protocol layer.

In FIGS. 8A and 8B, a value 801 indicates a hardware address of a packet transmission source. In the present example, since the packet is transmitted from the network interface-B 2011, the value 801 is the hardware address of the network interface-B 2011. A value 802 indicates an IP address of the packet transmission source, i.e. the IP address associated with the network interface-B 2011. A value 803 indicates the object ID and index of the MIB object on which information is to be returned, contained in the present responding SNMP message. Here, the object ID is 1.3.6.1.2.1.2.2.1.6, and the index is 1. These values are identical to those of the MIB object on which information has been requested, and are identical to the value 703 shown in FIG. 7B.

A value 804 is the MIB value of the value 803. This MIB object is ifPhysAddress. In the present example, since iflndex is designated as 1 in the step S401, the value of the hardware address is the value of the network interface-B 2011 which is the network interface having received the SNMP request for MIB information retrieval in the step S401. By doing so, in cases where the MIB object in the MIB information retrieval request received by the MFP 101 contains 1 as the value of iflndex, it is possible to return the information on the network I/F which has received the request, by regarding the value of iflndex as 1.

In the step S407, similarly to the above description, the MIB 301 performs creation of a MIB value without considering processing of ifIndex.

In the step S408, the SNMP 302 transmits the MIB value returned from the MIB 301 to the external apparatus which is the requesting source, by using the SNMP message, and then the process returns to the step S401.

By executing the above-described process, the MFP 101 returns the information in response to the SNMP request received from the external apparatus for MIB information retrieval.

According to the first embodiment, if iflndex is contained in a MIB information retrieval request received from the external apparatus by the MFP 101, and at the same time the value of if Index is designated as 1, it is possible to return a response by regarding the value of iflndex of the received network interface as 1. For example, assuming that the MIB object+index is 1.3.6.1.2.1.2.2.1.6.1, if the MIB information retrieval request is received via the network interface-A 2010, the hardware address of the network interface-A 2010 is returned, whereas if the MIB information retrieval request is received via the network interface-B 2011, the hardware address of the network interface-B 2011 is returned. Therefore, it is possible to return the information of the network interface which is expected by the external apparatus, i.e. the information of the network interface of the MFP 101, via which the external apparatus and the MFP 101 are actually in communication with each other. As a result, it is possible to return preferred information to the SNMP manager which retrieves the information by fixedly designating the value of iflndex as 1. Even when the network interface which is actually in communication with the external apparatus and the network interface designated by the external apparatus are different, it is possible to return the MIB information requested by the external apparatus in an appropriate manner.

Next, a second embodiment of the present invention will be described. An MFP which is an image forming apparatus as a communication apparatus according to the second embodiment has the same configuration as that of the MFP 101 which is the MFP image forming apparatus as the communication apparatus according to the first embodiment, described herein above with reference to FIGS. 1 and 2, and hence the description thereof is omitted.

The second embodiment is distinguished from the first embodiment in that the MIB is divided into a first MIB corresponding to the network interface-A 2010 and a second MIB corresponding to the network interface-B 2011.

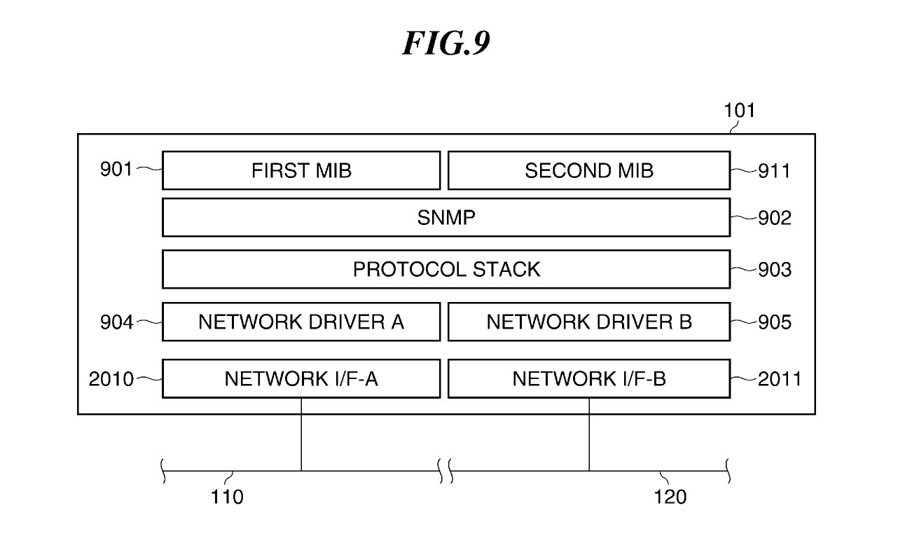

FIG. 9 is a block diagram showing software configuration of a communication function of the MFP 101 in the second embodiment. It should be noted that FIG. 9 shows only essential parts related to the present invention, and the essential parts partially include hardware.

A first MIB 901 and a second MIB 911 each comprise a database body of the MIB and software for constructing the database body. The first MIB 901 and the second MIB 911 each internally construct a database by collecting various kinds of information on the MFP 101, and returns a MIB value corresponding to an object ID and an index value designated by an SNMP 902, referred to hereinafter return. It is assumed that the first MIB 901 and the second MIB 911 each have a standard MIB (MIB 2).

The roles of the first MIB 901 and the second MIB 911, and the difference between the two are as follows: The first MIB 901 is a database of the MIB for responding to a MIB information retrieval request received via the network interface-A 2010. The second MIB 911 is a database of the MIB for responding to a MIB information retrieval request received via the network interface-B 2011.

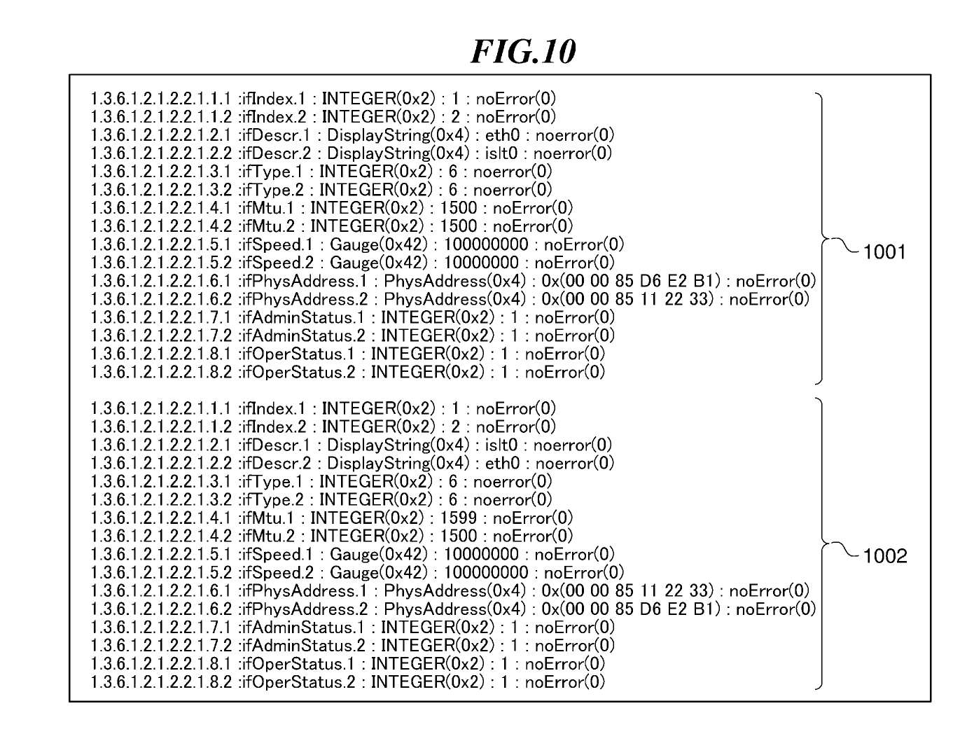

The difference between the two is that in the first MIB 901, the network interface-A 2010 is assigned a first value of ifIndex, and the network interface-B 2011 is assigned a second value of iflndex, whereas in the second MIB 911, the network interface-B 2011 is assigned a first value of iflndex, and the network interface-A 2010 is assigned a second value of iflndex. FIG. 10 shows the configuration of the MIB of the two, in a visualized form. FIG. 10 is a visualized format of MIB information of the first MIB 901 and the second MIB 911, and shows MIB values of part of the standard MIB (MIB 2).

Referring to FIG. 10, a region 1001 represents MIB values of the first MIB 901. Further, a region 1002 represents MIB values of the second MIB 911. By comparing the region 1001 and the region 1002, it is known that the order of iflndex is reverse between the first MIB 901 and the second MIB 911.

Referring again to FIG. 9, the SNMP 902 is an SNMP protocol agent. Based on a packet of an SNMP request received via the network interface-A 2010 or the network interface-B 2011, the SNMP 902 queries the first MIB 901 or the second MIB 911 about a value of the MIB object corresponding to the value of the object ID and index. If the SNMP request is received via the network interface-A 2010, the MIB to be queried is the first MIB 901, whereas if the SNMP request is received via the network interface-B 2011 and the second MIB 911 is queried. Then, the SNMP 902 receives the response of the MIB value from the first MIB 901 or the second MIB 911, creates a packet of an SNMP response, and then transmits the created packet to the external apparatus which is the requesting source.

A protocol stack 903 is responsible for a communication function of IP protocols, and is incorporated in the OS as standard equipment. A network driver A 904 is a device driver for controlling the network interface-A 2010. A network driver B 905 is a device driver for controlling the network interface-B 2011.

The software group of the application programs ranging from the MIB 901 to the network driver B 905, the network interface-A 2010, and the network interface-B 2011 is stored in the HDD 2004 when not in use, and each software program is loaded into the RAM 2002 as required, for execution by the CPU 2001. Further, the first MIB 901, the SNMP 902, and the second MIB 911 operate in an application space of the OS. The protocol stack 903 to the network driver B 905, and the network interface-A 2010 and the network interface-B 2011 operate in a kernel space of the OS.

It should be noted that the OS on which the software programs operate and software groups for realizing other functions of the MFP are also stored in the HDD 2004, and are each loaded into the RAM 2002 as required, for execution by the CPU 2001.

Further, in the present embodiment, it is assumed that an IP address associated with the network interface-A 2010 is 172.24.176.168, and a hardware address associated with the same is 000085D6E2B1. Further, it is assumed that an IP address associated with the network interface-B 2011 is 192.168.1.100, and a hardware address associated with the same is 000085112233.

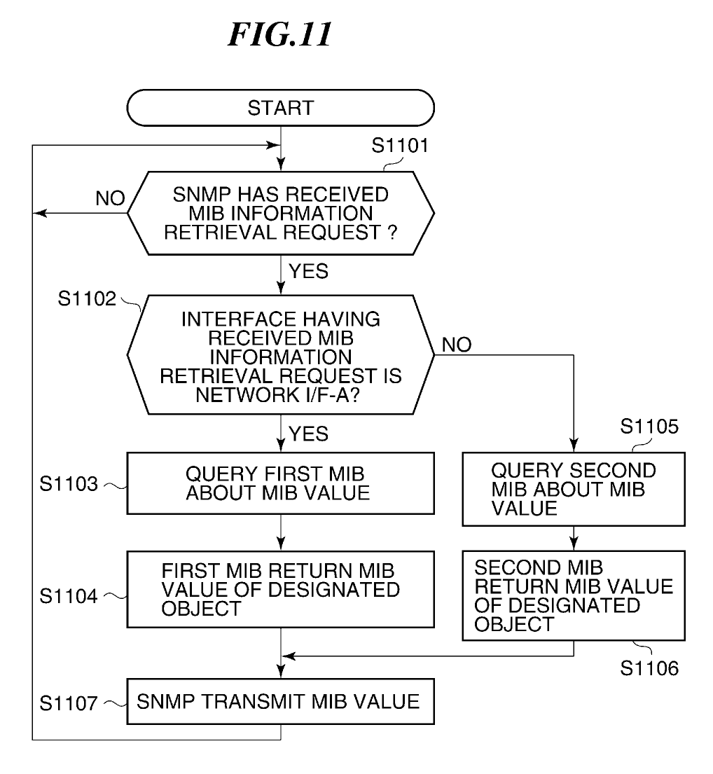

Next, a description will be given of an operation of the MFP 101 performed when an SNMP request is received, in the second embodiment, with reference to FIG. 11.

FIG. 11 is a flowchart of an operation process executed by the MFP 101 upon receipt of the SNMP request.

First, a description will be given of an operation performed when an SNMP request for MIB information retrieval is received via the network interface-A 2010.

In a step S1101, the SNMP 902 awaits an SNMP request for information retrieval from an external apparatus. The SNMP request for information retrieval is an SNMP message sent by the SNMP manager for requesting a SNMP agent to return a MIB value, such as a Get-Request message and a GetNext message.

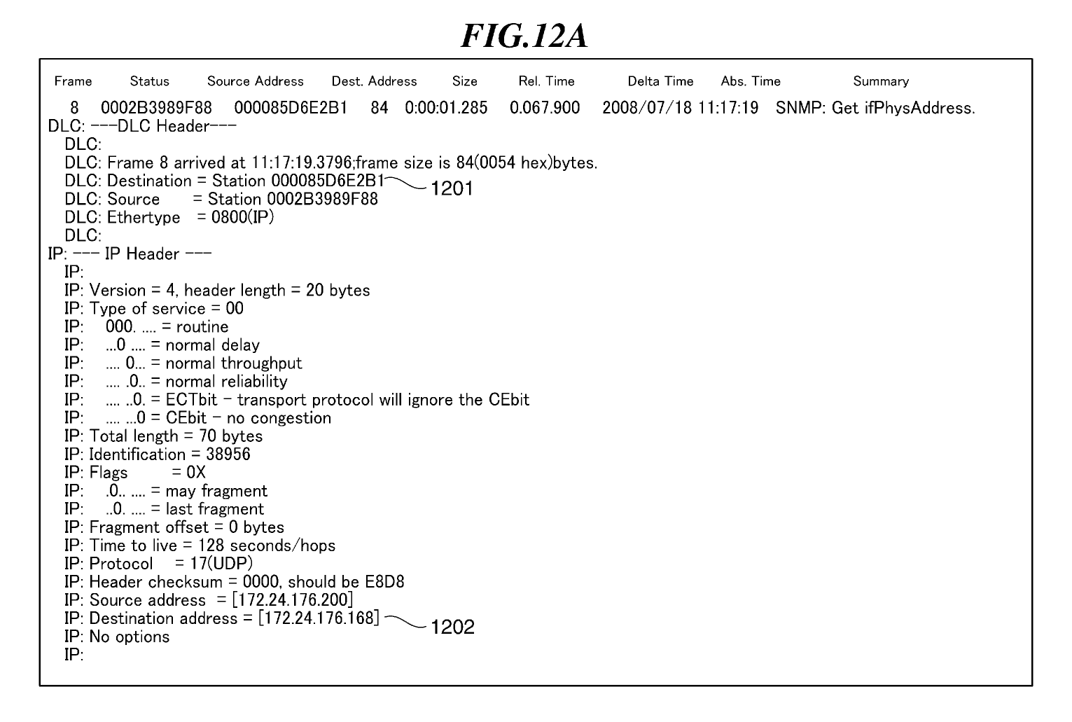

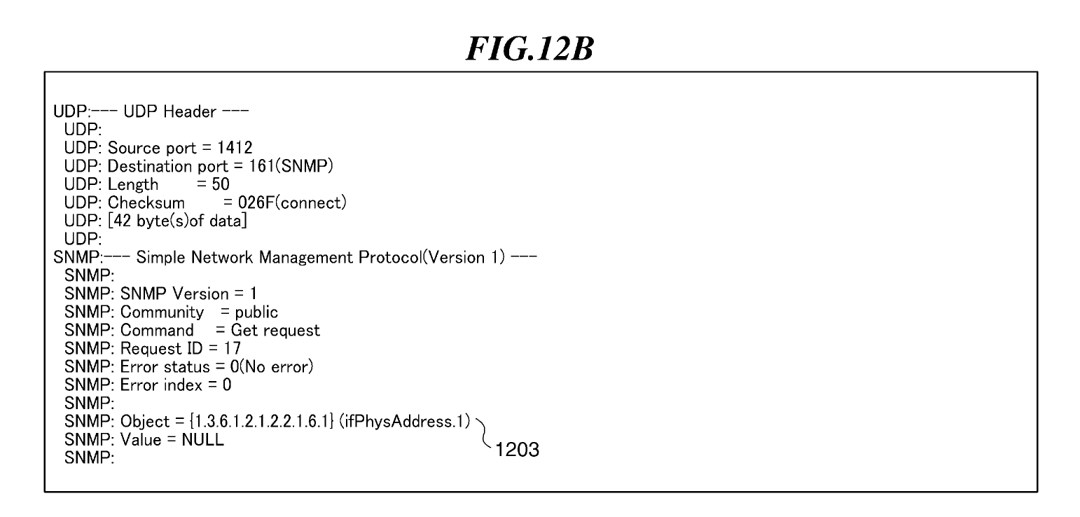

In the step S1101, if the SNMP 902 receives the SNMP request for MIB information retrieval, the process proceeds to a step S1102. FIGS. 12A and 12B show the contents of a network packet of the SNMP request for information retrieval, which is received by the MFP 101 via the network interface-A 2010, in a form visualized from the viewpoint of the protocol layer.

Referring to FIGS. 12A and 12B, a value 1201 indicates a destination hardware address in the data link layer. This value is the hardware address of the network interface-A 2010. A value 1202 indicates a destination IP address contained in the Internet layer. This value is the IP address associated with the network interface-A 2010. A value 1203 indicates the object ID and index of a MIB object, contained in the SNMP message, information on which is requested for retrieval. In this network packet, the object ID is 1.3.6.1.2.1.2.2.1.6 (ifPhysAddress), and the index is 1. Here, it is assumed that such a packet is received.

Referring again to FIG. 11, in the step S1102, the SNMP 902 determines whether or not the network interface which has received the MIB information retrieval request is the network interface-A 2010. In this step, based on the above-mentioned interface information, the SNMP 902 determines which of the network interface-A 2010 and the network interface-B 2011 is the network interface having received the SNMP request for MIB information retrieval. If it is determined that the network interface having received the MIB information retrieval request is the network interface-A 2010, the process proceeds to a step S1103. On the other hand, if the network interface having received the MIB information retrieval request is the network interface-B 2011, the process proceeds to a step S1105. Here, since the retrieval request is received via the network interface-A 2010, the process proceeds to the step S1103.

In the step S1103, the SNMP 902 performs processing of requesting the first MIB 901 to return a MIB value designated by the retrieval request. The SNMP 302 passes the object ID and index value designated by the SNMP request for information retrieval, which is received in the step S1101, to the first MIB 901 to request the corresponding MIB value.

Next, in a step S1104, the first MIB 901 creates a value corresponding to the designated MIB object+index, and performs processing of responding to the SNMP 902. In this step, the designated MIB object+index is 1.3.6.1.2.1.2.2.1.6.1. The value of 1.3.6.1.2.1.2.2.1.6.1 defined by the first MIB 901 is 000085D6E2B1, as indicated in the region 1001 shown in FIG. 10. That is, it is the MIB value of the network interface-A 2010 which has received the MIB information retrieval request.

In a step S1107, the SNMP 902 transmits the MIB value returned from the first MIB 901 to the external apparatus which is the requesting source by a SNMP message.

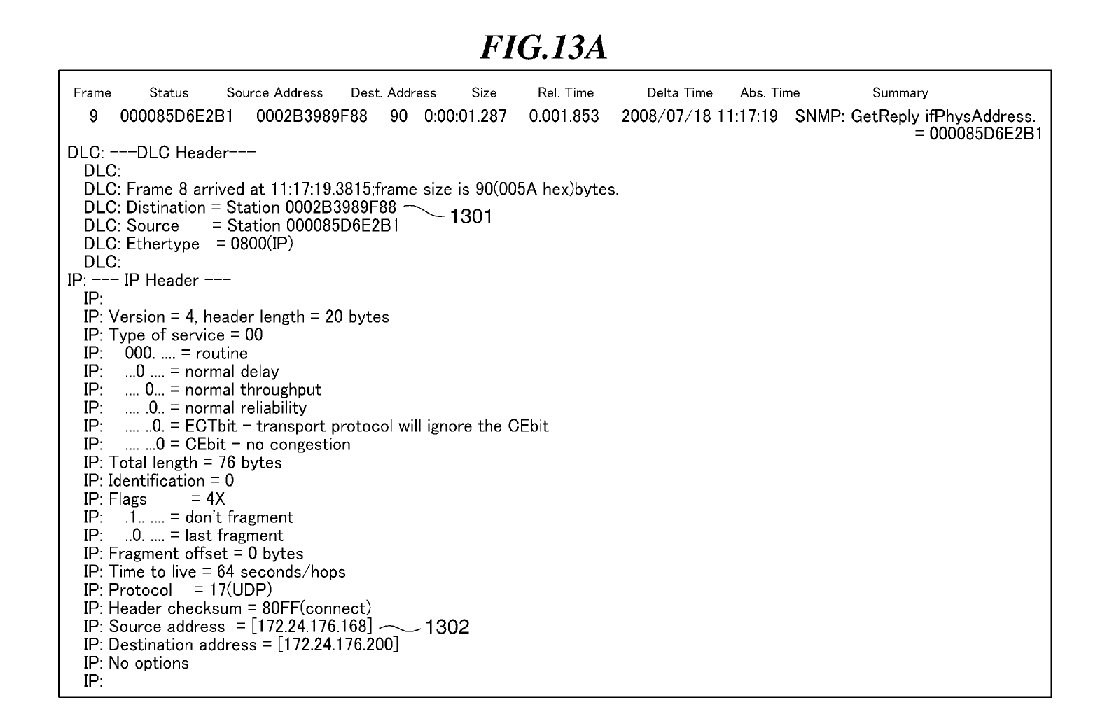

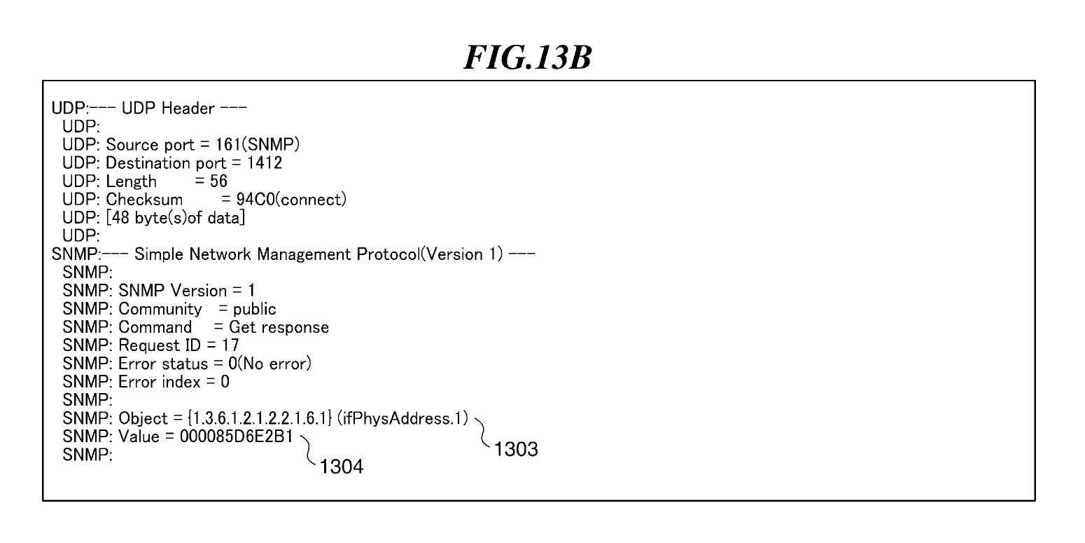

By executing the above-described processing, the MFP 101 returns the information in response to the SNMP request for MIB information retrieval, which is received from the external apparatus. FIGS. 13A and 13B shows the contents of a network packet of the SNMP response returned in the present example, in a form visualized from the viewpoint of the protocol layer.

Referring to FIGS. 13A and 13B, a value 1301 indicates a hardware address of the packet transmission source. In the present example, since the packet is transmitted from the network interface-A 2010, the value 1301 is the hardware address of the network interface-A 2010. A value 1302 indicates an IP address of the packet transmission source, i.e. the IP address associated with the network interface-A 2010. A value 1303 indicates the object ID and index of the MIB object on which information is to be returned, contained in the present responding SNMP message. Here, the object ID is 1.3.6.1.2.1.2.2.1.6, and the index is 1. These values are identical to those of the MIB object on which information has been requested, and are identical to the value 1203 shown in FIG. 12B.

A value 1304 is the MIB value of the value 1303. This MIB object+index is ifPhysAddress.1. In the present example, the MIB which is referred to is the first MIB 901, and the MIB value of ifPhysAddress. 1 is the value of the hardware address of the network interface-A 2010.

Next, a description will be given of an operation performed when an SNMP request for MIB information retrieval is received via the network interface-B 2011. It should be noted that in the case where same processing is executed as described hereinabove with reference to the steps S1101 to S1107, part of the description is omitted.

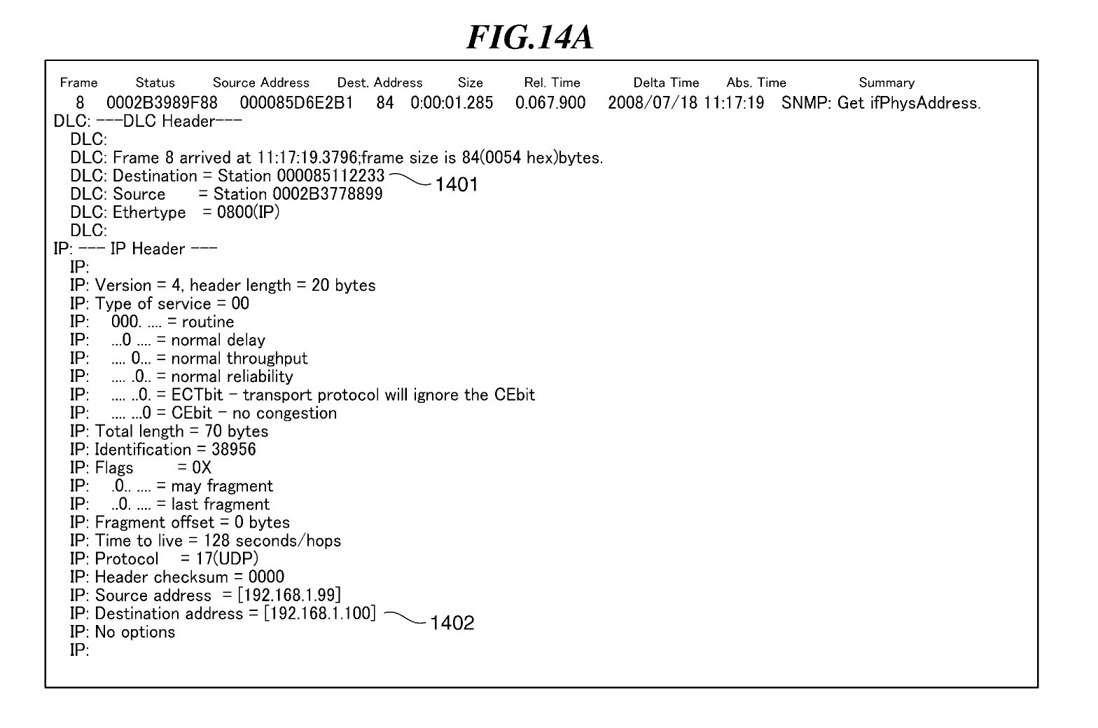

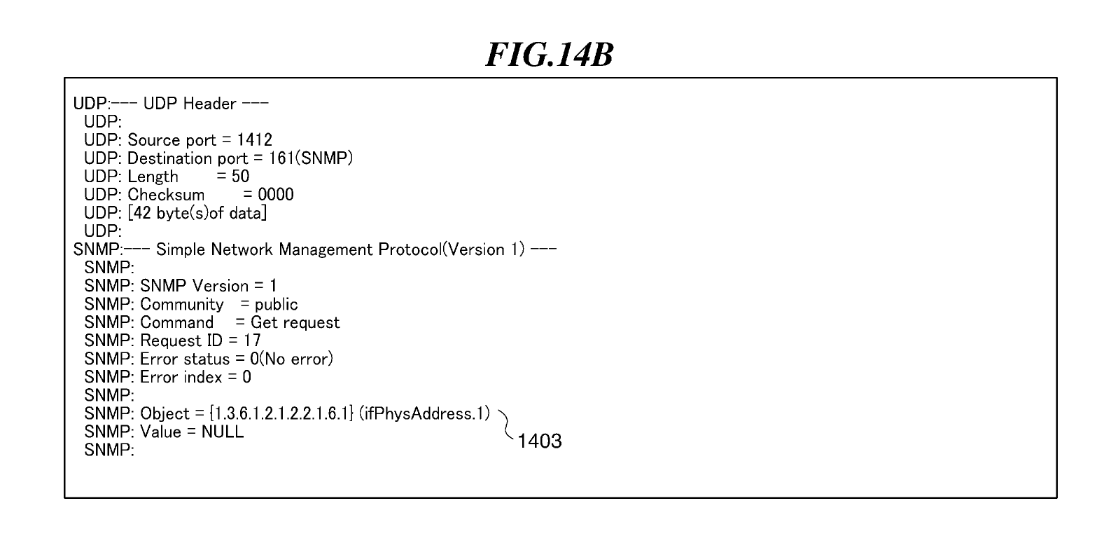

In the step S1101, the SNMP 902 awaits an SNMP request for information retrieval from an external apparatus. If the SNMP 902 receives an SNMP request for MIB information retrieval, the process proceeds to the step S1102. FIGS. 14A and 14B shows the contents of a network packet of the SNMP request for information retrieval, which is received by the MFP 101 via the network interface-B 2011, in a form visualized from the viewpoint of the protocol layer.

Referring to FIGS. 14A and 14B, a value 1401 indicates a destination hardware address in the data link layer. This value is the hardware address of the network interface-B 2011. A value 1402 indicates a destination IP address contained in the Internet layer. This value is the IP address associated with the network interface-B 2011. A value 1403 indicates the object ID and index of the MIB object on which information is to be returned, contained in the present responding SNMP message. Here, the object ID is 1.3.6.1.2.1.2.2.1.6 (ifPhysAddress), and the index is 1. In the present example, it is assumed that such a packet is received.

Referring again to FIG. 11, in the step S1102, similarly to the above description, the SNMP 902 determines whether or not the network interface which has received the MIB information retrieval request in the step S1101 is the network interface-A 2010. It is determined that the network interface which has received the MIB information retrieval request is the network interface-A 2010, the process proceeds to the step S1103. On the other hand, if the network interface which has received the request is the network interface-B 2011, the process proceeds to the step S1105. In the present example, since the retrieval request is received from the network interface-B 2011, the process proceeds to the step S1105.

In the step S1105, the SNMP 902 performs processing of requesting the second MIB 911 to send the MIB value designated by the retrieval request. The SNMP 902 passes the object ID and index value designated by the SNMP request for information retrieval, which is received in the step S1101, to the second MIB 911 to request the associated MIB value.

In a step S1106, the second MIB 911 creates a MIB value corresponding to the designated MIB object+index, and performs processing of returning the MIB value to the SNMP 902. Here, the designated MIB object+index is 1.3.6.1.2.1.2.2.1.6.1. The value of 1.3.6.1.2.1.2.2.1.6.1 defined by the second MIB 911 is 000085112233, as indicated by the region 1002 shown in FIG. 10. That is, it is the MIB value of the network interface-B 2011 which has received the MIB information retrieval request.

In the step S1107, the SNMP 902 transmits the MIB value returned from the second MIB 911 to the external apparatus which is the requesting source by an SNMP message.

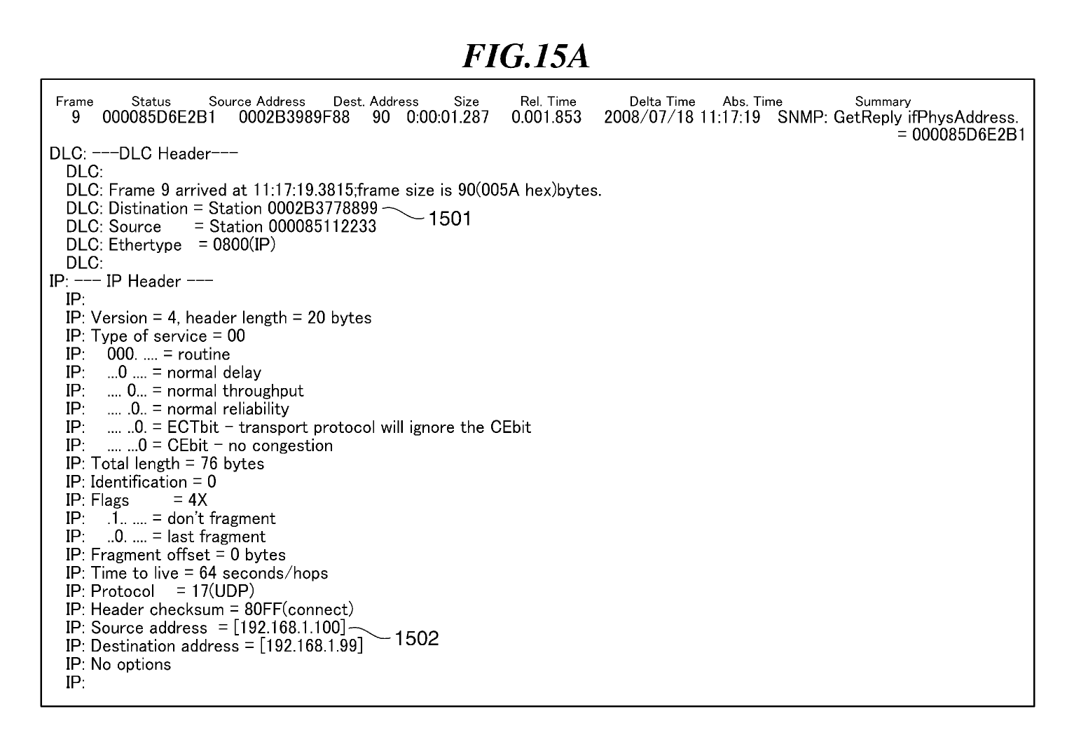

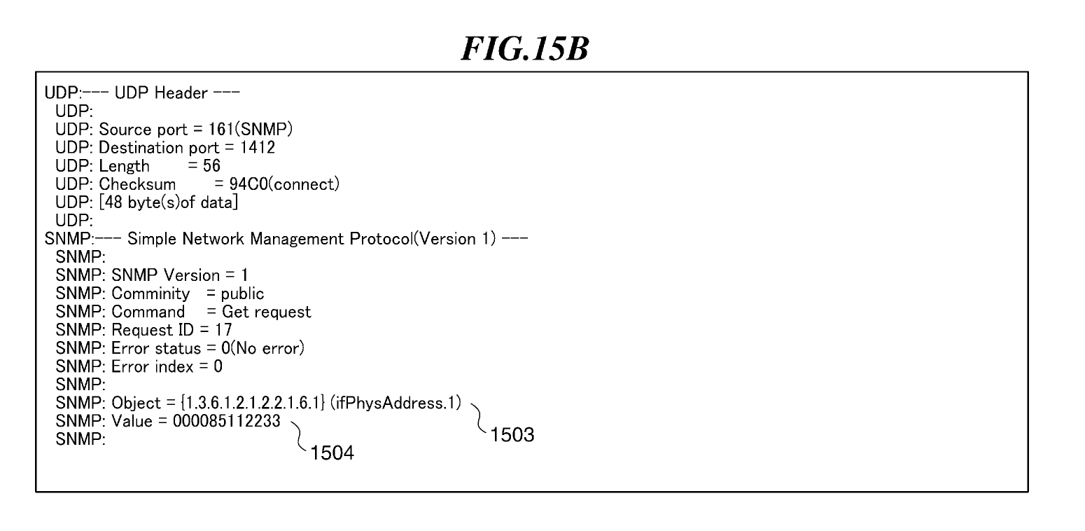

By executing the above-described process, the MFP 101 returns the information in response to the SNMP request received from the external apparatus for MIB information retrieval. FIGS. 15A and 15B show contents of a network packet of the SNMP response returned In the present example, in a form visualized from the viewpoint of the protocol layer.

Referring to FIGS. 15A and 15B, a value 1501 indicates a hardware address of the packet transmission source. In the present example, since the packet is transmitted from the network interface-B 2011, the value 1501 is the hardware address of the network interface-B 2011. A value 1502 indicates an IP address of the packet transmission source, i.e. the IP address associated with the network interface-B 2011. A value 1503 indicates the object ID and index of the MIB object on which information is to be returned, contained in the SNMP protocol response. In this network packet, the object ID is 1.3.6.1.2.1.2.2.1.6, and the index is 1. These values are identical to those of the MIB object on which information has been requested, and are identical to the value 1403 shown in FIG. 14B.

A value 1504 is the MIB value of the value 1503. This MIB object+index is ifPhysAddress. 1. The MIB which is referred to is the second MIB 911 in the present example, and the MIB value of ifPhysAddress. 1 is the value of the hardware address of the network interface-B 2011.

In the second embodiment, two MIBs are prepared in the MFP 101, i.e. the first MIB 901 to be referred to when the MIB information retrieval request is received via the network interface-A 2010, and the second MIB 911 to be referred to when the MIB information retrieval request is received via the network interface-B 2011. Then, the first MIB 901 is configured such that the first information of ifIndex is information on the network interface-A 2010, and the second MIB 911 is configured such that the first information of ifIndex is information on the network interface-B 2011. By doing so, when a MIB information retrieval request is received via the network interface-A 2010, it is possible to return information on the network interface-A 2010 in a case where the value of iflndex is designated as 1. Further, when a MIB information retrieval request is received via the network interface-B 2011, it is possible to return information on the network interface-B 2011 in a case where the value of iflndex is designated as 1. Therefore, it is possible to return preferred information to the SNMP manager which retrieves information by fixing the value of iflndex to 1. Even when a network interface which is actually in communication with an external apparatus and a network interface designated by the external apparatus are different, it is possible to properly return MIB information requested by the external apparatus.

Although in the above-described first and second embodiments, the present invention is applied to the MFP 101 as an image forming apparatus as the communication apparatus, this is not limitative, but it is to be understood that the present invention can be applied to information processing apparatuses, terminal units, etc. which have a communication capability.

Further, although the MFP 101 is connected to wired networks, i.e. the LAN-A 110 and the LAN-B 120, the present invention can also be realized by a configuration in which a wireless communication function is provided and connection to a plurality of networks can be performed by different wireless communication methods.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-230596, filed Oct. 2, 2009, which is hereby incorporated by reference herein in its entirety.

What is claimed is:

1. A communication apparatus including a first network interface, a second network interface, a communication unit for performing communication using SNMP via at least one of the network interfaces, and a storage unit for storing state information on the communication apparatus as MIB information, comprising:
a first determination unit configured to determine whether or not a value of interface information, which is contained in a MIB information retrieval request received by the communication unit from an external apparatus, is a predetermined value;
a second determination unit configured to determine which one of the network interfaces has received the MIB information retrieval request; and
a returning unit configured to create information corresponding to the first network interface from the MIB information and to return the created information to the external apparatus, if it is determined by the first determination unit that the value of the interface information is the predetermined value and if it is determined by the second determination unit that the first network interface has received the MIB information retrieval request, and
to create information corresponding to the second network interface from the MIB information and to return the created information to the external apparatus, if it is determined by the first determination unit that the value of the interface information is the predetermined value and if it is determined by the second determination unit that the second network interface has received the MIB information retrieval request.

2. The communication apparatus according to claim 1, wherein the storage unit stores the MIB information in a manner identifiable according to an object ID and an index,
wherein the object ID and the index are designated in the MIB information retrieval request, and
wherein the interface information is ifIndex.

3. The communication apparatus according to claim 1, wherein the predetermined value is 1.

4. The communication apparatus according to claim 1, wherein the storage unit stores the state information on the communication apparatus as a number of items of MIB information corresponding to the number of the network interfaces provided with the communication apparatus.

5. A method for controlling a communication apparatus including a first network interface, a second network interface, a communication unit for performing communication using SNMP via at least one of the network interfaces, and a storage unit for storing state information on the communication apparatus as MIB information, comprising:
determining whether or not a value of interface information, which is contained in a MIB information retrieval request received by the communication unit from an external apparatus, is a predetermined value;
determining which one of the network interfaces has received the MIB information retrieval request;
creating information corresponding to the first network interface from the MIB information and returning the created information to the external apparatus, if it is determined that the value of the interface information is the predetermined value and if it is determined that the first network interface has received the MIB information retrieval request, and
creating information corresponding to the second network interface from the MIB information and returning the created information to the external apparatus, if it is determined that the value of the interface information is the predetermined value and if it is determined that the second network interface has received the MIB information retrieval request.

6. A non-transitory computer-readable storage medium storing a computer-readable program for causing a computer to execute a method for controlling a communication apparatus including a first network interface, a second network interface, a communication unit for performing communication using SNMP via at least one of the network interfaces, and a storage unit for storing state information on the communication apparatus as MIB information,
wherein the method comprises:
determining whether or not a value of interface information, which is contained in a MIB information retrieval request received by the communication unit from an external apparatus, is a predetermined value;
determining which one of the network interfaces has received the MIB information retrieval request;
creating information corresponding to the first network interface from the MIB information and returning the created information to the external apparatus, if it is determined that the value of the interface information is the predetermined value and if it is determined that the first network interface has received the MIB information retrieval request, and creating information corresponding to the second network interface from the MIB information and returning the created information to the external apparatus, if it is determined that the value of the interface information is the predetermined value and if it is determined that the second network interface has received the MIB information retrieval request.
